(19) United States
(12) Patent Application Publication
(10) Pub. No.: US 2015/0162781 A1
(43) Pub. Date: Jun. 11, 2015

(54) Illumination-Based Charging System for Portable Devices

(71) Applicant: LSI Corporation, San Jose, CA (US)

(72) Inventors: Roger A. Fratti, Mohnton, PA (US); David L. Dreifus, Cary, NC (US); Albert Torressen, Bronx, NY (US); James R. McDaniel, Nazareth, PA (US)

(73) Assignee: LSI Corporation, San Jose, CA (US)

(21) Appl. No.: 14/104,537

(22) Filed: Dec. 12, 2013

Related U.S. Application Data
(60) Provisional application No. 61/912,654, filed on Dec. 6, 2013.

(51) Int. Cl. H02J 7/35; H02J 7/00

(52) U.S. Cl. CPC H02J 7/355; H02J 7/0027

(57) ABSTRACT

The disclosure is directed to illumination-based charging of one or more portable devices. According to an embodiment of the disclosure, an illumination-based charging pad includes a platform, a plurality of illumination sources, a plurality of photosensitive detectors, and a controller. The controller performs a scan by activating the illumination sources and detecting reflected illumination from an illuminated surface of at least one portable device disposed upon the platform. The controller determines a set of one or more illumination sources that are at least partially overlaid by the portable device based upon the detected illumination. The controller selects one or more illumination sources for charging the portable device at least partially based upon the set of one or more illumination sources determined to be overlaid by the portable device.

### PRIORITY

The present application claims priority under 35 U.S.C. §119(e) to U.S. Provisional Patent Application Ser. No. 61/912,654, entitled ILLUMINATION-BASED CHARGING SYSTEM FOR PORTABLE DEVICES, By Roger A. Fratti et al., filed Dec. 6, 2013, which is currently co-pending, or is an application of which currently co-pending application(s) are entitled to the benefit of the filing date. The above-referenced provisional patent application is hereby incorporated by reference in its entirety.

### FIELD OF INVENTION

The disclosure relates to the field of illumination-based energy transfer and more particularly to illumination-based charging of one or more portable devices.

### BACKGROUND

Portable electronic devices, such as mobile phones and tablets, are currently being manufactured with circuitry for contactless charging. For example, many portable devices are now configured for inductive charging through the use of coils built into or coupled (e.g. via a mobile phone or tablet case) to the device. In such systems, an electrical current to charge or power the portable device is induced by active coils in a compatible charging pad. Inductive energy transfer is an effective form of contactless charging; however, it requires protocol compatibility between device circuitry and pad circuitry and also requires a significant amount of space to incorporate the charging coils. Some portable devices are simply too small to incorporate the circuitry needed for inductive charging.

Illumination-based energy transfer has been used to power some portable devices, such as calculators, by using photosensitive receivers (e.g. solar cells) to harvest energy from ambient light. Although current implementations lack the efficiency needed for technical and commercial requirements of many modern electronics, illumination-based energy transfer offers great flexibility and can be improved through innovations in the art, some of which are disclosed herein.

### SUMMARY

Some embodiments of the disclosure are directed to a system and method for charging of portable devices using focused illumination from one or more illumination sources. In an embodiment, a system for charging one or more portable devices is structurally defined by a charging pad including a platform configured to support the portable devices, a plurality of photosensitive detectors, a plurality of illumination sources, and a controller in communication with the plurality of photosensitive detectors and the plurality of illumination sources. The controller is configured to activate the illumination sources to illuminate a surface of at least one portable device supported by the platform. The photosensitive detectors are then enabled to receive illumination reflected from the illuminated surface of the portable device. The controller is further configured to determine a set of one or more illumination sources which are located under the portable device based upon the detected illumination. The controller is then configured to activate or maintain activity of a selection of one or more illumination sources from the plurality of illumination sources based upon the set of one or more illumination sources that are determined to be overlaid by the portable device. The active illumination sources provide illumination suitable for transferring energy (i.e. charging) the portable device via illumination directed towards a photosensitive receiver (e.g. a photovoltaic cell) of the portable device.

Some embodiments of the disclosure are directed to a portable device configured for illumination-based charging. In an embodiment, a portable device includes a photosensitive receiver configured to generate an electrical current in response to being impinged upon by illumination. The portable device further includes a battery configured to store the electrical current generated by the photosensitive receiver. A controller directly or indirectly coupled with the battery is configured to determine a status indicative of a charging state of the battery and a status indicative of a charging link established between the photosensitive receiver and at least one illumination source of a charging pad, such as the system described above. The portable device further includes an indicator configured to convey the status indicative of the charging state of the battery and the status indicative of the charging link established between the photosensitive receiver and active illumination sources of the charging pad.

It is to be understood that both the foregoing general description and the following detailed description are not necessarily restrictive of the disclosure. The accompanying drawings, which are incorporated in and constitute a part of the specification, illustrate embodiments of the disclosure, wherein like numbers represent like characters.

### BRIEF DESCRIPTION OF THE DRAWINGS

The embodiments of the disclosure may be better understood by those skilled in the art by reference to the accompanying figures in which:

FIG. 1 is a block diagram conceptually illustrating an illumination-based charging system, in accordance with an embodiment of the disclosure;

FIG. 2A is a lateral view conceptually illustrating the illumination-based charging system, wherein a charging platform is supporting one or more portable devices, in accordance with an embodiment of the disclosure;

FIG. 2B is a lateral view conceptually illustrating the illumination-based charging system, wherein a plurality of illumination sources are activated to determine spatial occupancy and position of the one or more portable devices, in accordance with an embodiment of the disclosure;

FIG. 2C is a lateral view conceptually illustrating the illumination-based charging system, wherein active illumination sources are providing illumination to charge the one or more portable devices, in accordance with an embodiment of the disclosure;

FIG. 2D is a top view conceptually illustrating the illumination-based charging system, wherein the active illumination sources are providing illumination to charge the one or more portable devices, in accordance with an embodiment of the disclosure;

FIG. 3A is lateral view conceptually illustrating the illumination-based charging system, wherein some of the active illumination sources are proximate to an optical receiver of the portable device, in accordance with an embodiment of the disclosure;

FIG. 3B is top view conceptually illustrating the illumination-based charging system, wherein some of the active illumination sources are proximate to the optical receiver of the portable device, in accordance with an embodiment of the disclosure;

FIG. 4A is a block diagram conceptually illustrating a portion of a portable device, in accordance with an embodiment of the disclosure;

FIG. 4B is a block diagram of an indicator of the portable device, wherein the indicator is a wireless transmitter, in accordance with an embodiment of the disclosure;

FIG. 4C is a conceptual illustration of the indicator of the portable device, wherein the indicator is a visual indicator, in accordance with an embodiment of the disclosure; and

FIG. 5 is a flow diagram illustrating a method for illumination-based charging of one or more portable devices, in accordance with an embodiment of the disclosure.

### DETAILED DESCRIPTION

Reference will now be made in detail to the embodiments disclosed, which are illustrated in the accompanying drawings.

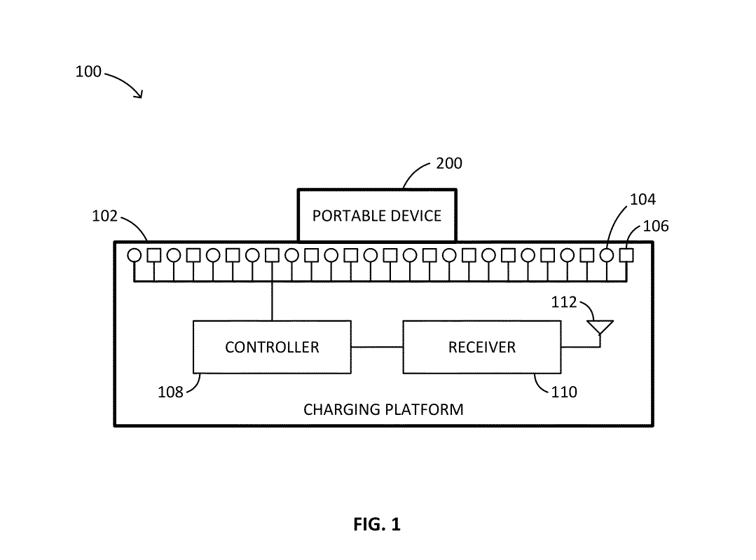

FIGS. 1 through 5 illustrate embodiments of a system and method for illumination-based charging of one or more portable devices. Portable electronic devices, such as mobile phones, tablets, ultrabooks, netbooks, media players, cameras, and add-on battery packs, can be modified with circuitry for illumination-based or optical charging, as described by Srinivasa Raavi et al., An Optical Wireless Power Transfer System for Rapid Charging, Dept. of Electr. Enginering, Univ. of North Texas, Denton, Tex., USA (2013) and U.S. Pat. No. 7,514,899, issued on Apr. 7, 2009. The foregoing patent and non-patent literature are entirely incorporated herein by reference, and those skilled in the art will appreciate that the circuitry and configurations described in these references may be applicable to some embodiments of this disclosure.

Looking now to FIG. 1, an embodiment of an illumination-based charging system 100 is illustrated in the structural form of a charging pad 100. Hereinafter, system 100 is often referred to as “charging pad 100;” however, it is noted that embodiments of system 100 do not necessarily form charging pads. Alternative forms are contemplated, and as such, usage of the term “charging pad” is not intended to limit the disclosure in any way. The charging pad 100 includes a platform 102 configured to physically support one or more portable devices 200. The charging pad 100 further includes a plurality of illumination sources 104, such as light emitting diodes (LEDs), and a plurality of photosensitive detectors 106, such as photodiodes, photoresistors, photocells or the like, distributed across one or more regions of the platform 102.

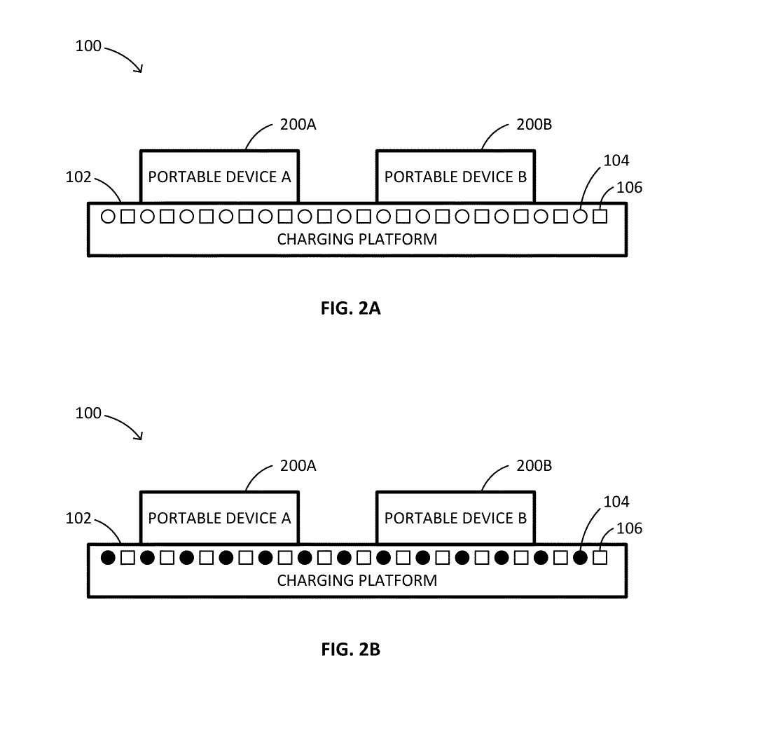

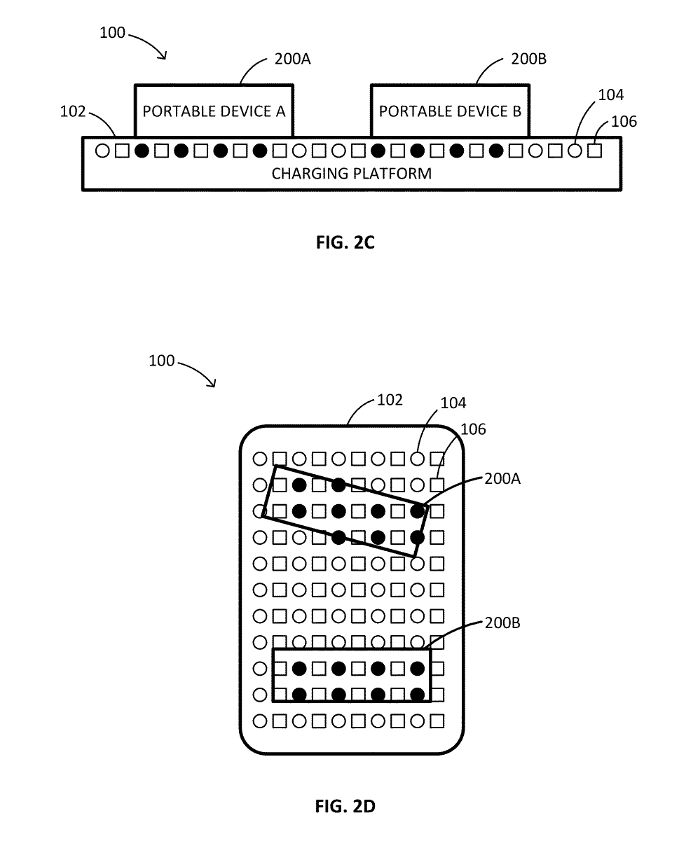

In some embodiments, the illumination sources 104 and photosensitive detectors 106 are arranged substantially uniformly as illustrated in FIGS. 2A through 2D. However, it can be advantageous to alternatively provide a non-uniform distribution or a plurality of discrete distributions to efficiently accommodate several ranges of device sizes. In some embodiments, for example, the illumination sources 104 are arranged according to a first (higher density) distribution within a first region of the platform 102 for charging smaller portable devices 200 and at least a second (lower density) distribution within a second region of the platform 102 for charging larger portable devices 200. Distributing the illumination sources 104 non-uniformly or according to alternative distribution densities enables higher density portions of the charging pad 100 to be used on an as-needed basis. Accordingly, manufacturing costs are reduced because fewer sources 104 are needed to accommodate different device sizes and power efficiency is maintained because large portable devices 200 placed on lower density portions of the charging pad 100 are not illuminated with more illumination sources 104 than needed.

The charging pad 100 further includes at least one controller 108, such as a processor or a microcontroller, in communication with the illumination sources 104 and the photosensitive detectors 106. The controller 108 is configured to signal the illumination sources 104 and photosensitive detectors 106 to perform a scan to determine position and spatial occupancy of one or more portable devices 200 placed upon the platform 102. As shown in FIG. 2B, the controller 108 is configured to activate (e.g. turn on or pulse) the illumination sources 104 to illuminate a surface of at least one portable device 200 that has been placed upon the platform 102. In some embodiments, by activating the illumination sources 104, the controller 108 simultaneously scans for a plurality of portable devices 200, such as a first portable device 200A and a second portable device 200B. The photosensitive detectors 106 are configured to receive illumination reflected from the surface of the portable device 200 or surfaces of multiple portable devices 200A and 200B supported by the platform 102. The controller 108 is configured to then determine one or more sets illumination sources 104 or portions of the platform 102 that are at least partially overlaid by the one or more portable devices 200 based upon the detected illumination from portable devices 200.

As shown in FIGS. 2C and 2D, the controller 108 is further configured to activate or maintain activity of one or more selections of illumination sources 104 based upon the one or more sets of illumination sources 104 determined to be at least partially overlaid by the one or more portable devices 200. In some embodiments, for example, the controller 108 is configured to activate or maintain activity of the selected illumination sources 104 by powering on or intensifying a selection of illumination sources 104 that are located completely or at least partially beneath the one or more portable devices 200 in order to provide illumination suitable for transferring energy (i.e. charging) to the portable devices 200 placed upon the platform 102. In some embodiments, the controller 108 is configured to select only illumination sources that are completely overlaid by the portable device 200 to avoid any stray illumination emanating from partially uncovered illumination sources 104. The controller 108 is further configured to keep the remaining (non-selected) illumination sources 104 in an inactive (e.g. powered down) state until another scan is performed.

According to various embodiments, the controller 108 is configured to perform a scan to determine position and spatial occupancy of one or more portable devices 200 placed upon the platform 102 periodically, according to a user input, or upon detecting placement of one or more portable devices 200 upon the platform 102. In some embodiments, the controller 108 is configured to scan the array of illumination sources 104 and photosensitive detectors 106 at predetermined time intervals to detect the placement of a new portable device 200 upon the platform 102. In some embodiments, the charging pad 100 further includes a conventional proximity sensor, such as a physical force sensor, an electromagnetic force sensor, an optical sensor, or the like, configured to detect the physical presence of a new portable device 200 being placed upon the platform 102. When a new portable device 200 is detected via periodic scanning or proximity detection, the controller 108 is configured to scan for position and spatial occupancy of the newly detected portable device 200 and activate or maintain activity of a selection of illumination sources 104, as described above, to begin charging the newly detected portable device 200. In some embodiments, the charging pad 100 further includes a user interface (e.g. button, switch, toggle, or touchscreen) for signaling initiation of a scan for position and spatial occupancy of newly placed portable devices 200 according to a user input.

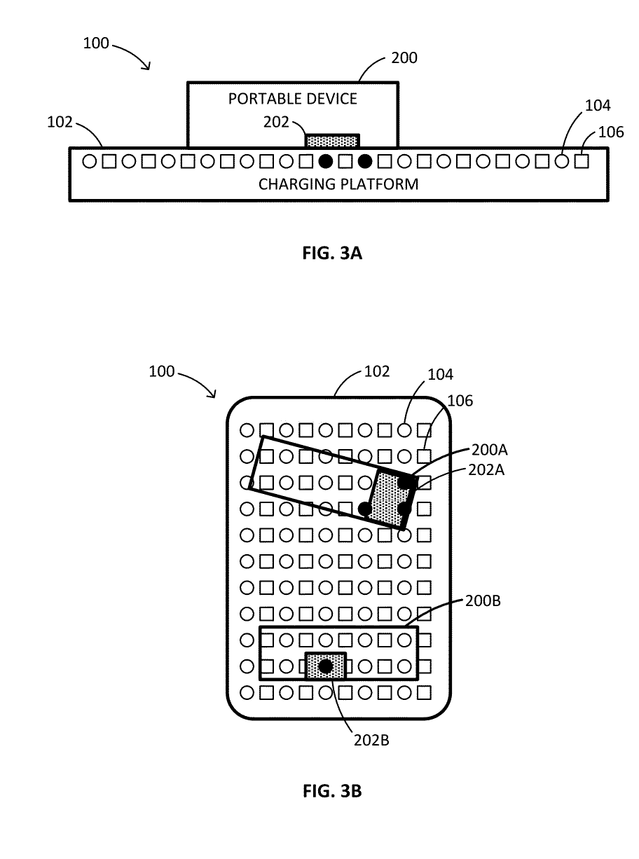

FIGS. 3A and 3B illustrate embodiments where the controller 108 is further configured to restrict the selection of illumination sources that are activated or maintained in an active state based upon a location of a photosensitive receiver 202 (e.g. solar cell or photovoltaic cell) in the portable device 200. By activating illumination sources proximate to the photosensitive receiver 202 of each portable device 200, the controller 108 avoids unnecessary consumption of energy due to activation of illumination sources that do not contribute to charging of the portable device 200.

In some embodiments, the controller 108 is configured to determine an approximate position of the photosensitive receiver 202 of the portable device 200 according to a visible indicator (e.g. LED) or recognizable feature (e.g. marking, pattern, or high reflectance material) detected during a scan of the portable device 200. In some embodiments, the controller 108 is configured to determine an approximate position of the photosensitive receiver 202, according to a stored location associated with the detected position and spatial occupancy of the portable device 200. As shown in FIG. 3B, different portable devices 200A/200B may include photosensitive receivers 202A/202B having different locations or sizes. Accordingly, it is advantageous for the controller 108 to be enabled to detect the position of the photosensitive receiver 202 of each portable device 200 or the illumination sources 104 proximate to each photosensitive receiver 202 regardless of the device placement.

In some embodiments, the controller 108 is additionally or alternatively configured to determine one or more illumination sources 104 in proximity of the photosensitive receiver 202 of the portable device 200 based upon a status indicative of the charging link established between the illumination sources 104 and the photosensitive receiver 202. According to the embodiment illustrated in FIG. 1, the charging pad 100 further includes a receiver 110 coupled with an antenna 112 to enable receipt of communications from the portable device 200 regarding charging state (e.g. charging, not charging, battery level, charging complete) or an indication of a charging link (e.g. strength of link or charging rate) established between the photosensitive receiver 202 and one or more active illumination sources 104. In some embodiments, the receiver 110 is configured for BLUETOOTH, NFC, WLAN communication or any other suitable wireless communication protocol.

The charging pad 100 may additionally or alternatively be configured to receive communications from the portable device 200 regarding the charging state of the device battery or an established charging link in the form of exchanged optical pulses or signals. For example, at least one indicator light or a visual display of the portable device 200 may be configured to convey a status indicative of the charging activity/inactivity state or a status indicative of the charging link strength via an encoded optical signal or by providing illumination with a pattern, pulse rate, color, and/or intensity that is indicative of the communicated status. Accordingly, in some embodiments, the controller 108 is configured to receive an optically communicated status indicative of the charging activity/inactivity state of the portable device 200 or indicative of the charging link established between the photosensitive receiver 202 of the portable device 200 and one or more active illumination sources 104 via at least one photosensitive detector 106 or another optical receiver of the charging pad 100. It is further contemplated that various portions of the illumination spectrum (e.g. visible or non-visible spectral) ranges may be employed for different purposes. For example, two or more different wavelengths or spectral ranges may be used, respectively, for two or more of device proximity or spatial occupancy detection, device charging, status communication, or the like.

In some embodiments, the controller 108 is configured to perform a scan by individually activating each illumination source 104 or subset of the illumination sources 104 determined to be overlaid by the portable device 200 and receiving a status indicative of the charging link (if any) established between each individually activated illumination source 104 or subset of the illumination sources 104 and the photosensitive receiver 202. By scanning the illumination sources 104 overlaid by the portable device 200 and receiving the status indicative of the charging link established by each illumination source 104 or subset of the illumination sources 104 individually, the controller 108 is enabled to determine one or more illumination sources 104 in proximity of the photosensitive receiver 202 of the portable device 200 (i.e. illumination sources associated with stronger charging links or higher charging rates). Accordingly, the controller 108 is enabled to restrict the selection of active illumination sources 104 for charging the portable device 200 to those in proximity of the photosensitive receiver 202. This greatly improves efficiency of energy transfer between the charging pad 100 and the portable device 200 because illumination sources 104 that do not contribute or only slightly contribute to charging the portable device 200 are not activated or are powered down, while those illumination sources 104 that do contribute are activated, maintained active, or intensified.

In some embodiments, the controller 108 is further configured to deactivate illumination sources 104 selected for charging the portable device 200 based upon receiving a status indicative of the charging state of the portable device 200, such as when the battery of the portable device 200 is fully charged. In some embodiments, the controller 108 is configured to reduce the number of active illumination sources 104 or lower the illumination intensity of the active illumination sources 104 rather than completely powering off the illumination sources 104 to maintain a low charging rate so that the portable device 200 is substantially maintained in a fully charged state. Those skilled in the art will appreciate that many portable electronic devices 200, such as mobile phones, tablets, media players (e.g. POD TOUCH), or the like, continue to run in a low power mode where emails are updated or other background applications continue to refresh. Accordingly, at least a low charge rate is required to keep the battery fully charged because power consumption continues even when the portable device 200 is not in active use.

From time to time, an electronic device without illumination-based charging capability or a non-chargeable object may be placed upon the platform 102. It is, therefore, advantageous for the charging pad 100 to discriminate between portable devices 200 that are enabled for illumination-based charging and other non-chargeable devices or objects that are unintentionally placed upon the platform 102. The charging pad 100 may be configured to do so via communication (e.g. wirelessly received RF signals or optical pulses as described above) with the portable device 200. In some embodiments, after a predetermined time period, the controller 108 is configured to automatically deactivate the illumination sources 104 selected for charging the portable device 200 if no status is received to indicate of a charging activity/inactivity state or established charging link between at least one illumination source 104 and the photosensitive receiver 202 of the portable device 200.

It is contemplated, however, that a portable device 200 with a completely depleted battery may be placed upon the platform 102. Accordingly, the portable device 200 may be unable to convey a status. Alternatively, a portable device 200 that is configured for illumination-based charging but unable to convey statuses may be placed upon the platform 102. In some embodiments, to avoid unintentionally deactivation of the illumination sources 104 selected for charging the portable device 200, the controller 108 is configured to function in at least a first mode where the illumination sources 104 are automatically deactivated after the predetermined time period if no status is received from the portable device 200 and a second mode where the automatic deactivation is disabled. In some embodiments, the controller 108 is switched between the first mode and the second mode according to a user input (e.g. via a button, switch, toggle, or touch interface). In some embodiments, the controller 108 is further configured to function in the first mode and the second mode substantially simultaneously. For example, the controller 108 may have automatic deactivation enabled (i.e. first mode) for a first portable device 200A placed upon the platform and automatic deactivation disabled (i.e. second mode) for a second portable device 200B placed upon the platform.

In some embodiments, the controller 108 is set to a default mode (i.e. the first mode or the second mode) and is configured to receive a user input for switching to another mode upon detecting placement of a portable device 200 on the platform 102. For example, the default mode may be the first mode where the automatic deactivation is enabled. When a portable device 200 is placed upon the platform 102 and scanned (as discussed above) to activate a selection of illumination sources 104 for charging the portable device 200, the controller 108 may be configured to switch to the second mode where automatic deactivation is disabled if a user input is received within the predetermined time period (i.e. before the illumination sources 102 are automatically deactivated).

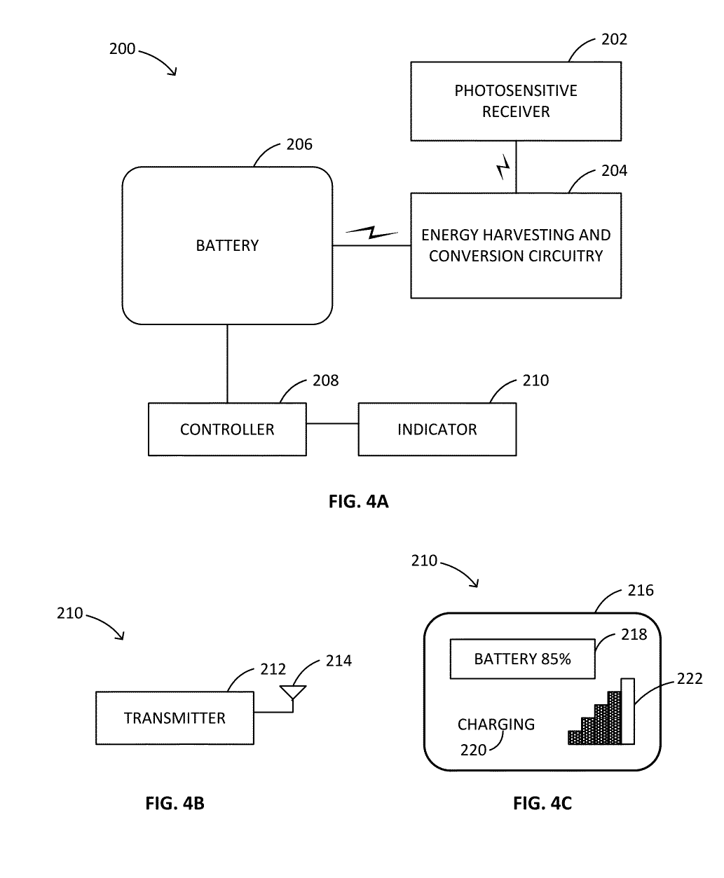

FIG. 4A illustrates circuitry within a portable device 200 to enable contactless charging via an illumination-based energy transfer system, such as the charging pad 100 described above. In some embodiments, the portable device 200 is a mobile phone, tablet, ultrabook, netbook, media player, camera, or an electronic accessory, such as a BLUETOOTH handset, a smart watch, an add-on battery pack, or the like. The portable device 200 includes a photosensitive receiver 202, such as a solar or photovoltaic cell, configured to generate an electrical current in response to being impinged upon by illumination. The generated current is stored by a battery 206 after being transferred through energy harvesting and conversion circuitry 204, such as a transmission gate and a step up DC-DC converter, coupled between the photosensitive receiver 202 and the battery 206. A controller 208 is coupled to the battery 206 via an electrical current sensor and is configured to determine a status indicative of a charging state of the battery 206 (e.g. charging, not charging, fully charged, battery level) and a status indicative of a charging link (e.g. strength of charging link, charging rate) established between the photosensitive receiver 202 and one or more active illumination sources 104 of the charging pad 100 (FIG. 1). The controller 208 is further coupled with an indicator 210 configured to convey the status indicative of the charging state of the battery 206 and the status indicative of the established charging link.

FIGS. 4B and 4C illustrate various embodiments of the indicator 210. In an embodiment shown in FIG. 4B, the indicator 210 includes a transmitter 212 coupled with an antenna 214 for wirelessly transmitting to the user the status indicative of the charging state of the battery 206 or the status indicative of an established charging link between the photosensitive receiver 202 and one or more active illumination sources 104 of the charging pad 100. In another embodiment shown in FIG. 4C, the indicator 210 includes at least one visual indicator 216, such as a display (e.g. LCD or LED display), indicator lights (e.g. colored LEDs), or the like, configured to visually display the charge/charging status of the battery in the form of textual or symbolic notifications. In some embodiments, for example, the status indicative of the charging state of the battery 206 includes an indication 218 of the percentage of the battery capacity that is charged or an indication 220 of charging activity/inactivity. In some embodiments, the status indicative of the charging link includes an indication 222 of the strength of the charging link or a rate of the charging (i.e. incoming) current from the photosensitive receiver 202.

In some embodiments, a user is enabled to align the photosensitive receiver 202 of the portable device 200 with one or more of the active illumination sources 104 by reference to the visual indication 222. For example, the user may move the portable device 200 to a position on the charging pad 100 where the visual indication 222 conveys a relatively strong charging link or rapid charging rate. Accordingly, the user can avoid energy waste or slow charging due misalignment. In some embodiments, the platform 102 may further include an alignment guide, such as a stenciled outline or markings of source locations, to aid alignment.

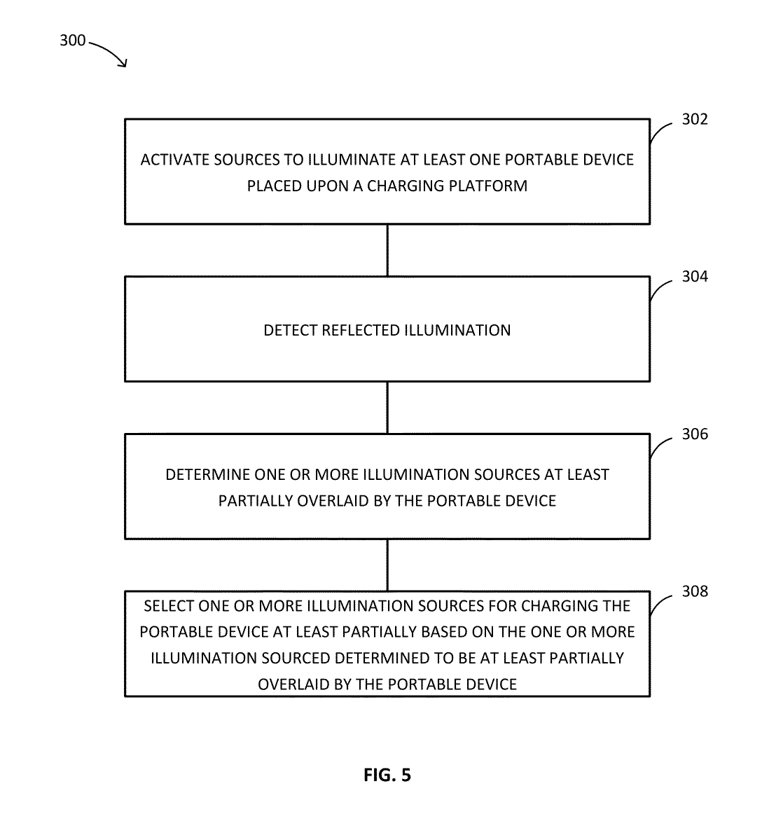

FIG. 5 illustrates an embodiment of a method 300 of illumination-based charging of one or more portable devices 200 (FIG. 1). In some embodiments, method 300 is manifested by the charging pad 100 and the portable device 200 described above. As such, some embodiments of method 300 include a step for carrying out any feature or function described with regard to embodiments of the charging pad 100 and the portable device 200. It is noted, however, that the embodiments of the charging pad 100 and the portable device 200 described above are not intended to limit method 300. Unless otherwise noted, method 300 should be understood to encompass any systems or devices configured to execute one or more of the following steps.

An initial scan is performed via steps 302 and 304 to detect position and spatial occupancy of portable devices 200 placed upon a charging platform 102. At step 302, a plurality of illumination sources 104 are activated (e.g. turned on or pulsed) to illuminate at least one portable device 200 placed upon a charging platform 102. At step 304, illumination reflected off a surface of the portable device 200 is detected utilizing a plurality of photosensitive detectors 106.

At step 306, a set of illumination sources 104 or portions of the charging platform 102 being at least partially overlaid by the portable device 200 is determined based upon the detected illumination. For example, the illumination sources 104 and photosensitive detectors 106 may be distributed such that an illumination source 104 and a photosensitive detector 106 form a pair, and illumination detected by the photosensitive detector 106 is indicative of the corresponding illumination source 104 being overlaid by at least a portion of the portable device 200.

At step 308, one or more of the illumination sources 104 are selected for charging the portable device 200, at least partially based upon whether or not the illumination sources 104 are overlaid by the portable device 200. In some embodiments, the selection of active illumination sources 104 is further based upon a determined or approximated location of a photosensitive receiver 202 of the portable device 200. Accordingly, the portable device 200 is charged via the illumination sources proximate to the photosensitive receiver 202 of the portable device, as described above with reference to FIGS. 3A and 3B.

It should be recognized that the various functions, operations, or steps described throughout the present disclosure may be carried out by any combination of hardware, software, or firmware. In some embodiments, various steps or functions are carried out by one or more of the following: electronic circuits, logic gates, field programmable gate arrays, multiplexers, controllers, or computing systems. A computing system may include, but is not limited to, a personal computing system, mainframe computing system, workstation, image computer, parallel processor, or any other device known in the art. In general, the terms “controller” and “computing system” are broadly defined to encompass any device having one or more processors, which execute instructions from a carrier medium.

Program instructions implementing methods, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, or a magnetic tape.

It is further contemplated that any embodiment of the disclosure manifested above as a system or method may include at least a portion of any other embodiment described herein. Those having skill in the art will appreciate that there are various embodiments by which systems and methods described herein can be effected, and that the implementation will vary with the context in which an embodiment of the disclosure is deployed.

Furthermore, it is to be understood that the invention is defined by the appended claims. Although embodiments of this invention have been illustrated, it is apparent that various modifications may be made by those skilled in the art without departing from the scope and spirit of the disclosure.

What is claimed is:

1. A system for charging one or more portable devices, comprising:
a platform configured to support one or more portable devices;
a plurality of photosensitive detectors;
a plurality of illumination sources; and
a controller in communication with the plurality of photosensitive detectors and the plurality of illumination sources; the controller being configured to:
activate the plurality of illumination sources to illuminate a surface of a portable device supported by the platform,
determine a set of one or more illumination sources from the plurality of illumination sources being at least partially overlaid by the portable device based upon reflected illumination received by the plurality of photosensitive detectors from the illuminated surface of the portable device, and
activate or maintain activity of a selection of one or more illumination sources from the plurality of illumination sources to direct illumination towards at least a portion of the surface of the portable device, the active selection of one or more illumination sources being at least partially based upon the set of one or more illumination sources determined to be overlaid by the portable device.

2. The system of claim 1, wherein the controller is further configured to:
determine a second set of one or more illumination sources from the plurality of illumination sources being at least partially overlaid by a second portable device based upon reflected illumination received by the plurality of photosensitive detectors from an illuminated surface of the second portable device, and
activate or maintain activity of a second selection of one or more illumination sources from the plurality of illumination sources to direct illumination towards at least a portion of the surface of the second portable device, the second active selection of one or more illumination sources being at least partially based upon the second set of one or more illumination sources determined to be overlaid by the second portable device.

3. The system of claim 1, wherein the controller is further configured to:
perform a periodic scan utilizing the plurality of illumination sources and the plurality of photosensitive detectors to determine when one or more portable devices are placed upon the platform.

4. The system of claim 1, further comprising:
a proximity sensor configured to detect placement of one or more portable devices upon the platform.

5. The system of claim 4, wherein the proximity sensor comprises at least one of a physical force sensor, an electromagnetic force sensor, and an optical sensor.

6. The system of claim 1, wherein the controller is further configured to:
determine at least one illumination source in proximity of a photosensitive receiver of the portable device, wherein the active selection of one or more illumination sources is at least partially based upon the at least one illumination source determined to be in proximity of the photosensitive receiver.

7. The system of claim 6, wherein the controller is further configured to:
receive a status indicative of a charging link established between the photosensitive receiver of the portable device and the at least one illumination source of the plurality of illumination sources, wherein the at least one illumination source determined to be in proximity of the photosensitive receiver is at least partially based upon the status indicative of the charging link established between the photosensitive receiver of the portable device and the at least one illumination source of the plurality of illumination sources.

8. The system of claim 6, wherein the controller is further configured to:
determine a location of the photosensitive receiver of the portable device at least partially based upon detection of an indicator or a recognizable feature on the portable device, wherein the at least one illumination source determined to be in proximity of the photosensitive receiver is at least partially based upon the determined location of the photosensitive receiver of the portable device.

9. The system of claim 1, wherein the controller is further configured to:
deactivate the selection of one or more illumination sources at least partially based upon receiving a status indicative of a charging state of a battery of the portable device.

10. The system of claim 1, wherein the plurality of illumination sources are distributed according to at least a first distribution density corresponding to a first portion of the platform and a second distribution density corresponding to a second portion of the platform.

11. A portable device, comprising:
a photosensitive receiver configured to generate an electrical current in response to being impinged upon by illumination;
a battery configured to store the electrical current generated by the photosensitive receiver;
a controller configured to determine a status indicative of a charging state of the battery and a status indicative of a charging link established between the photosensitive receiver and at least one illumination source of a plurality of illumination sources of a charging pad; and
an indicator configured to convey the status indicative of the charging state of the battery and the status indicative of the charging link established between the photosensitive receiver and the at least one illumination source.

12. The portable device of claim 11, wherein the status indicative of the charging link established between the photosensitive receiver and the at least one illumination source includes an indication of a strength of the charging link established between the photosensitive receiver and the at least one illumination source.

13. The portable device of claim 11, wherein the indicator comprises:
a visual indicator configured to display the status indicative of the charging link established between the photosensitive receiver and the at least one illumination source.

14. The portable device of claim 11, wherein the indicator comprises:
a transmitter configured to send the status indicative of the charging link established between the photosensitive receiver and the at least one illumination source to the charging pad.

15. The portable device of claim 14, wherein the transmitter is further configured to send the status indicative of the charging state of the battery to the charging pad.

16. A method of charging one or more portable devices, comprising:
activating a plurality of illumination sources to illuminate a surface of a portable device supported by a platform;
detect reflected illumination from the illuminated surface of the portable device;
determining a set of one or more illumination sources from the plurality of illumination sources being at least partially overlaid by the portable device based upon the detected illumination; and
activating or maintaining activity of a selection of one or more illumination sources from the plurality of illumination sources to direct illumination towards at least a portion of the surface of the portable device, the active selection of one or more illumination sources being at least partially based upon the set of one or more illumination sources determined to be overlaid by the portable device.

17. The method of claim 16, further comprising:
determining at least one illumination source in proximity of a photosensitive receiver of the portable device, wherein the active selection of one or more illumination sources is at least partially based upon the at least one illumination source determined to be in proximity of the photosensitive receiver.

18. The method of claim 17, further comprising:
receiving a status from the portable device indicative of a charging link established between the photosensitive receiver of the portable device and the at least one illumination source of the plurality of illumination sources, wherein the at least one illumination source determined to be in proximity of the photosensitive receiver is at least partially based upon the status indicative of the charging link established between the photosensitive receiver of the portable device and the at least one illumination source of the plurality of illumination sources.

19. The method of claim 17, further comprising:
determining a location of the photosensitive receiver of the portable device at least partially based upon an indicator or a recognizable feature on the portable device, wherein the at least one illumination source determined to be in proximity of the photosensitive receiver is at least partially based upon the determined location of the photosensitive receiver of the portable device.

20. The method of claim 16, further comprising:
receiving a status indicative of a charging state of a battery of the portable device; and
deactivating the selection of one or more illumination sources at least partially based upon the status indicative of the charging state of the battery of the portable device.
